(19) United States
(12) Patent Application Publication
(10) Pub. No.: US 2005/0134038 A1
(43) Pub. Date: Jun. 23, 2005

(54) Fitting for fluid conveyance

(75) Inventor: Brian J. Walsh, Holland, OH (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation, Cleveland, OH (US)

(21) Appl. No.: 11/016,160

(22) Filed: Dec. 17, 2004

Related U.S. Application Data
(60) Provisional application No. 60/530,687, filed on Dec. 17, 2003.

(51) Int. Cl. F16L 41/00

(52) U.S. Cl. 285/125.1; 285/133.11; 285/131.1

(57) ABSTRACT

A fitting for a fluid connector comprising a body that accepts a main conduit and connects to a branch conduit where the main conduit is inserted through an opening in the body. An aperture is formed in the main conduit such that the main conduit and branch conduit are in fluid communication.

### CROSS REFERENCE TO RELATED APPLICATIONS

This application claims priority to Provisional Application 60/530,687, filed on Dec. 17, 2003, the contents of which are hereby incorporated by reference herein in their entirety.

### TECHNICAL FIELD

The present invention relates to fluid fittings or connectors for tubing and in particular to a connector that provides a branch connection for a tube without separating the tube.

### BACKGROUND OF THE INVENTION

There are many industrial applications where a relatively high pressure hydraulic system requires that branch connections be made between a tube and a component such as another fluid handling system, pump, motor, valve, switch, sensing device or the like. The fluid transfer tube may be made out of steel, aluminum, or a copper material where bonding methods in addition to brazing are used to attach the additional outlet, commonly known as a “T-fitting”. Prior art hydraulic systems have historically involved separating the tubing and then using threaded or brazed fittings to make branch connections.

When using a brazed connection, the tube is typically cut and a connector is positioned within the flowpath of the tube, with the tube ends being inserted into female ends of the connector. If the tubing has been pre-formed by forming a series of bends therein, the tubing ends must be properly aligned before brazing to ensure that the desired pre-formed shape is not altered as the connector is installed. Also, when installing a connector in a pre-formed tube, a section of tube must be removed and discarded to account for the increased length provided by the connector. The connector is then brazed to the tube. A second tube can be connected to a branch section of the connector. While these prior art connectors may be adequate for their intended purpose, disadvantages for particular applications exist.

One disadvantage of a brazed connector is that any protective coating, such as a corrosion resistance coating, or surface on the tubing and connector must be reapplied after the brazing process since the heat of the brazing process will typically remove at least a portion of this coating. The use of a brazing furnace, or other coating methods, and subsequent recoating is both expensive and time consuming. Therefore, the brazing process requires cutting the tubing twice, discarding a section of tubing, attaching the connector, aligning the tubing ends, brazing both connector ends to the tubing, and recoating the tubing and connector, by electroplating or electro-deposition or the like. Another disadvantage of prior connectors is that a reliable seal with the tube is difficult to achieve as installation steps are eliminated. What is needed, therefore, is a connector that can be connected to a tube such that the protective coating is not removed or altered. A favorable connector would require fewer steps to install, thereby reducing the amount of time and expense for the installation.

### SUMMARY OF THE INVENTION

Fluid connectors are provided that eliminate the number of steps required for installation, eliminate required brazing and coating processes and the environmental impact of resulting waste streams, eliminate wasted tubing, and/or reduce the cost of installation. Since industry accepted pre-coated tube is used, the need for multiple sites for plating is eliminated. The connector can be slid onto the tube, thereby eliminating the need for cutting the tube. An aperture can be pierced into the tubing, thereby reducing the shavings and other contamination associated with cutting the tubing. The connector can be slid onto the tubing prior to installing bends, thereby permitting the connection to be formed during subsequent operations while eliminating the step of aligning the portions of a separated tube prior to brazing.

A fluid connector according to an exemplary embodiment has a hollow body defining a first opening, a second opening, a third opening and a main passageway. The main passageway interconnects the first and second openings and the third opening is in fluid communication with the main passageway. The first opening is also defined by a cylindrical surface that selectively extends around a conduit.

Another embodiment provides a coupling system for a plurality of fluid conduits that includes a first conduit and a connector. The connector includes a first end defining a first opening, a second end defining a second opening, and a main passageway extending therebetween. The first conduit is interposed through the main passageway, and a cross-section of the connector, taken normal to a main axis of the connector, defines a circular surface that extends around an outer surface of the first conduit.

A further embodiment provides a method of interconnecting a plurality of fluid conduits that includes inserting a main conduit through a main passageway of a connector, where the main passageway is sealed around the circumference of at least a portion of the main conduit.

### BRIEF DESCRIPTION OF THE DRAWINGS

The present invention will now be described, by way of example, with reference to the accompanying drawings, in which:

FIG. 1 illustrates a planar view of a fitting for fluid conveyance according to an embodiment.

FIG. 2 is a sectional side view of the fitting of FIG. 1 shown with a conduit interposed therein.

FIG. 3 is a partial sectional view of a further embodiment of a T-fitting in accordance with the present invention.

FIG. 4 is a sectional view of a Y-fitting according to an alternate embodiment of the present invention.

FIG. 5 is sectional view of an X-fitting according to a further alternate embodiment of the present invention.

### DESCRIPTION OF THE PREFERRED EMBODIMENT

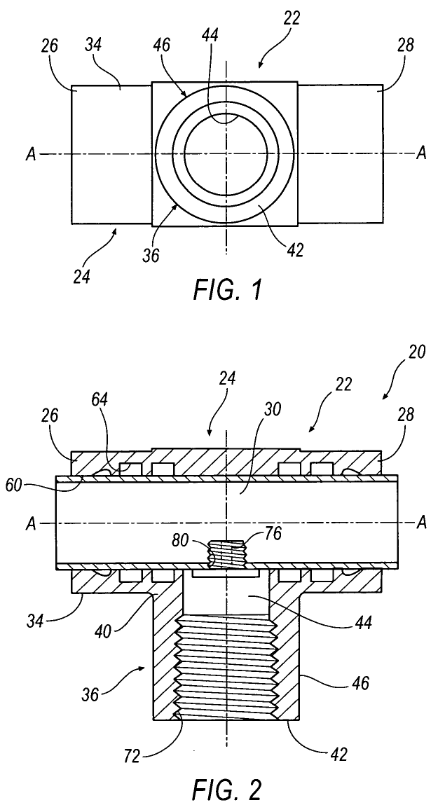

Referring to FIGS. 1 and 2, a fitting, coupling, or connector 20 is illustrated. Connector 20 includes a main body 22 having a main portion 24 extending from a first end 26 to a second end 28, and defining a main passageway 30 having an axis A-A and an outer surface 34. Main body 22 further includes a branch portion 36 extending from main portion 24 at a branch end 40 to a third end 42 and defining a branch passageway 44 and an outer surface 46.

As best seen in FIG. 2, main portion 24 includes a generally cylindrical surface 60 defining the main passageway 30 with annular grooves 64 formed therein. Annular grooves 64, as discussed below, accommodate seals (not shown). Branch passageway 44 is in fluid communication with main passageway 30. An integral main conduit 70 is interposed through main passageway 30, extending beyond first and second ends 26, 28. A piercing member, or hollow screw, 76 is shown extending through an aperture 80 formed in main conduit 70. Branch portion 36 includes a connection port 72 for connecting branch portion 36 to a second conduit (not shown). Interior threads are shown for connection port 72, but exterior threads or other connecting mechanisms known in the art may be used to connect branch portion 36 to a second conduit.

An embodiment of coupling connector 20 to main conduit 70 involves inserting a main conduit 70 into main passageway 30 and then inserting a self-tapping, hollow screw 76 partially into aperture 80. Thus provided, the interference between the branch passageway 44 and the portion of the hollow screw 76 that extends beyond an outer surface of the main conduit 70 restrains connector 20 both axially and circumferentially on the main conduit 70, allowing the seals disposed in annular grooves 64 to prevent leakage of fluid between main passageway 30 and the main conduit 70. The hollow screw 76 allows an internal portion of the main conduit 70 to be in fluid communication with the branch passageway 44. An advantage of this approach is that it allows a degree of relative axial and circumferential movement between connector 20 and the main conduit 70 when desired, while eliminating the need for crimping first and second ends 26, 28.

Another embodiment of securing connector 20 to main conduit 70 is to crimp first end 26 and/or second end 28. This crimping can be performed in any known way, including a 4, 6 or 8-jaw crimper. This crimping secures connector 20 to main conduit 70, thereby inhibiting relative axial and circumferential movement therebetweeen. As an example, a 4-jaw crimper would contact first end 26 adjacent branch end 40 with four separate, radially moveable, circumferentially spaced jaws. The jaws are then forced radially inward to distort first end 26, thereby securing first end 26 onto main conduit 70. Depending upon the amount of force used, first end 26 will begin to distort to a square shape. During this crimping process, main conduit 70 may be distorted as well, up to and including a resulting square shape, when viewed along axis A-A. This distortion of first end 26 and main conduit 70 provides some degree of resistance for relative torques about axis A-A of connector 20 and main conduit 70. The distortion of first end 26 and main conduit 70 also limits the relative movement between connector 20 and main conduit 70 along the A-A axis as adjacent portions of first end 26 and main conduit 70 remain undistorted.

Crimping first end 26 about annular grooves 64 with seals disposed therein has been found to provide an adequate coupling between connector 20 and main conduit 70, while allowing the seals to continue to perform a sealing function. Each of these approaches to coupling connector 20 to main conduit 70 and forming aperture 80 may be used with any embodiment of a connector described herein. A six-jaw crimper begins to form a hexagonal shape in first end 26 and an eight-jaw crimper begins to form an octagonal shape in first end 26 as the connector is secured to the main conduit.

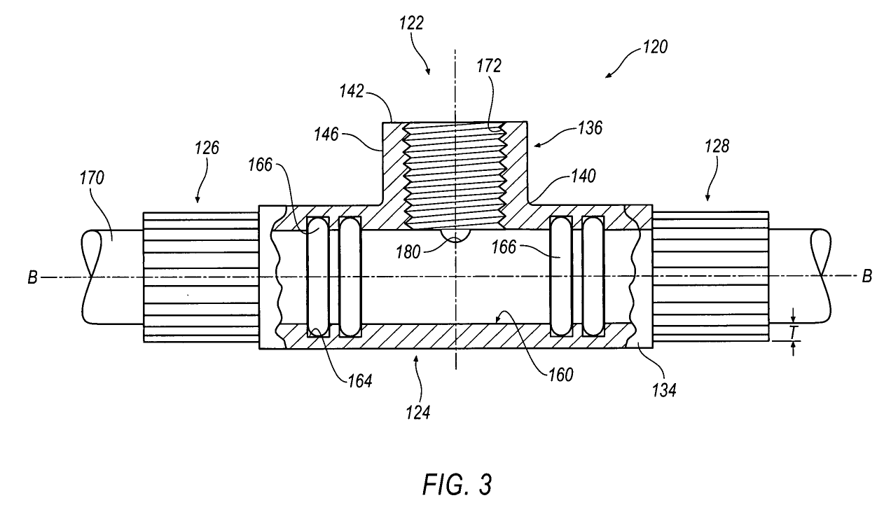

With reference to FIG. 3, an alternate embodiment of connector 20 is illustrated as a connector 120. Connector 120 includes a main body 122 having a main portion 124 extending from a first end 126 to a second end 128, and defining a main passageway 130 having an axis B-B and an outer surface 134. Main body 122 further includes a branch portion 136 extending from main portion 124 at a branch end 140 to a third end 142 and defining a branch passageway 144 and an outer surface 146.

Main portion 124 includes a generally cylindrical surface 160 defining a portion of the main passageway 130 with annular grooves 164 formed therein. Annular grooves 164 retain seals 166 that form a seal between main portion 124 and a main conduit, first conduit, or tube, 170. Preferably, seals 166 are o-rings. Branch passageway 144 is in fluid communication with main passageway 130. Branch portion 136 includes a connection port 172 for connecting branch portion 136 to a second conduit (not shown). Outer surfaces 134, 146 have an optional coating applied thereto.

The first end 126 and the second end 128, with thickness T, are illustrated in FIG. 3 crimped onto first conduit 170 with an 8-jaw crimper. Differences between crimping connectors 20 and 120 include connector 120 may be crimped in a location that would not distort seals 166, and connector 20 can be used in a location where a shorter distance between first end 26, 126 and second end 28, 128 is desired. This crimping operation for connector 120 is sufficient to couple first and second ends 126, 128 to first conduit 170 while not distorting any coating on connector 120 and main conduit 170 to the extent that the underlying material is exposed. In this manner, connector 120 may be connected to first conduit 170 while not requiring a re-coating operation. Furthermore, the crimping operation may provide an adequate seal between first and second ends 126, 128 and first conduit 170 to alleviate the need for seals 166. To affect this sealing during the crimping operation, cylindrical surface 160 may be provided with a sealing layer, such as a polymer or a soft metal.

The crimping process may sufficiently distort first end 126, second end 128, and portions of the main conduit adjacent first and second ends 126, 128 that the eight-jaw crimper forms a generally distorted octagonal shape. An advantage of this shape is that, as mentioned earlier, it provides resistance for relative torques about axis B-B of connector 120 and main conduit 170 and limits the relative movement between connector 120 and main conduit 170 along the B-B axis. Where greater torque and axial movement resistance are desired, a four-jaw crimper may be used to form a generally distorted square shape.

FIG. 3 further illustrates an aperture 180 formed in main conduit 170. Aperture 180 allows main conduit 170 to be in fluid communication with branch passageway 144. Aperture 180 may be formed in any variety of ways, including piercing, tapping, or drilling, and may also be formed or enlarged during the installation of the second conduit. Also, aperture 180 may be any shape and size as desired, provided that aperture 180 does not extend beyond the sealing between connector 120 and main conduit 170. Furthermore, aperture 180 may be formed after the installation and/or use of main conduit 170, so as to provide for a system modification, or a drain or a sample location that can be readily closed.

Aperture 180 may be performed in the same process step as the crimping of ends 126, 128 to further eliminate costs and time associated with the installation of connector 120. For installations such as a power steering pressure transducer, a small aperture 180 of about ⅛ inch in diameter may be formed, although other diameters may be formed.

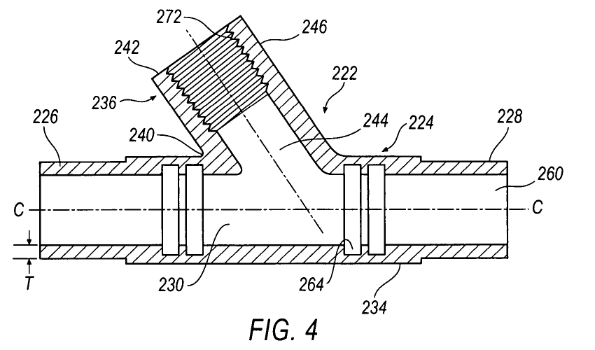

FIG. 4 illustrates another embodiment of connector 20 as Y-fitting 220. Y-fitting 220 includes a main body 222 having a main portion 224 extending from a first end 226 to a second end 228, and defining a main passageway 230 having an axis C-C and an outer surface 234. Main body 222 further includes a branch portion 236 extending from main portion 224 at a branch end 240 to a third end 242 and defining a branch passageway 244 and an outer surface 246.

Main portion 224 includes a generally cylindrical surface 260 defining the main passageway 230 with annular grooves 264 formed therein. Annular grooves 264 accommodate seals. Branch passageway 244 is in fluid communication with, and extends at a relative angle to, main passageway 230. Branch portion 236 includes a connection port 272 for connecting branch portion 236 to a second conduit (not shown). The Y-fitting 220 accommodates either the hollow screw of FIG. 2 or the aperture of FIG. 3 to provide fluid communication between branch passageway 244 and main passageway 230. First and second ends 226, 228 can be crimped as described above for securing connector 220 to a main conduit.

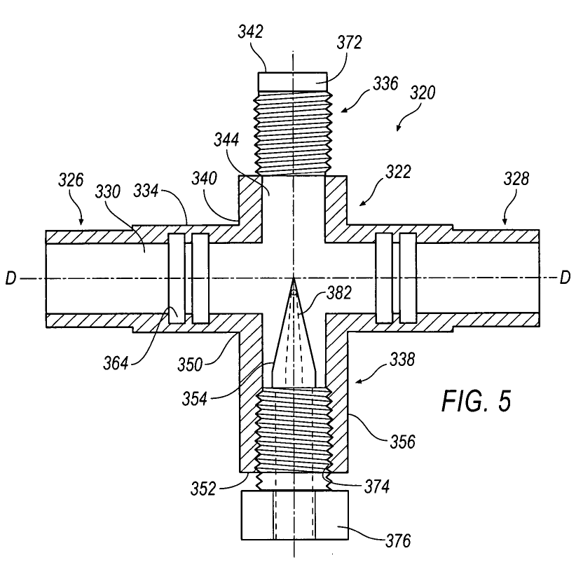

FIG. 5 illustrates a further embodiment of connector 20 as X-fitting 320. X-fitting 320 includes a main body 322 having a main portion 324 extending from a first end 326 to a second end 328, and defining a main passageway 330 having an axis D-D and an outer surface 334. Main body 322 further includes a branch portion 336 and a second branch portion 338. Branch portion 336 extends from main portion 324 at a branch end 340 to a third end 342 and defines a branch passageway 344 and an outer surface 346. Second branch portion 338 extends from main portion 324 at a branch end 350 to a fourth end 352 and defines a second branch passageway 354 and a second outer surface 356.

Main portion 324 includes a generally cylindrical surface 360 defining a main passageway with annular grooves 364 formed therein. Annular grooves 364 accommodate seals. Branch passageway 344 is in fluid communication with main passageway 330. Branch portion 336 includes a connection port 372 for connecting branch portion 336 to a second conduit (not shown). Second branch portion 338 includes a connection port 374 for connecting second branch portion 338 to a second conduit (not shown) or for use as a drain, charging location, sample port, or test location. The X-fitting 320 would accommodate either the hollow screw of FIG. 2 or the aperture of FIG. 3 to provide fluid communication between branch passageway 344 and main passageway 330. First and second ends 326, 328 can be crimped as described above for securing connector 320 to a main conduit.

An embodiment of coupling connector 320 to a main conduit involves inserting a main conduit into main passageway 330 and then inserting a piercing member, or second conduit, 376 into connecting port 372. The second conduit 376 is provided with a piercing end 378 that can form an aperture in the main conduit and couple with the main conduit in such a manner so as to restrict relative axial movement between connector 320 and the main conduit. This connection may alleviate the need for crimping first and second ends 326, 328. A hollow passage 382 allows an internal portion of the main conduit to be in fluid communication with the second conduit 376. The piercing end 382 of the second conduit 376 may be self-tapping in order to form the aperture, or may be inserted into a pre-formed aperture. An exemplary piercing end is disclosed in U.S. Pat. No. 5,322,083, the disclosure of which is incorporated by reference in its entirety.

During installation of any of the disclosed connectors, 20, 120, 220, 320 seals, as desired, are positioned in annular grooves 64, 164, 264, 364. The main conduit is inserted through main passageway 30, 130, 230, 330 as connector 20, 120, 220, 320 is radially and axially aligned with the main conduit to a desired location to form a coupling system. First end 26, 126, 226, 326 and second end 28, 128, 228, 328 are crimped, as desired, to secure connector 20, 120, 220, 320 to the main conduit. Thus assembled, connector 20, 120, 220, 320 provides a connection port 72, 172, 272, 372 to for main conduit. An aperture is formed in the main conduit, either before, after, or during the assembly of the main conduit and connector 20, 120, 220, 320. The second conduit may be coupled with connection port 72, 172, 272, 372 to provide the coupling system with a fluid-tight connection between the main conduit and the second conduit.

Preferably, main body 22, 122, 222, 322 is constructed of steel and the coating is a zinc-nickel plating for corrosion resistance and to protect against other environmental concerns, although main body 22, 122, 222, 322 may be constructed of other materials such as brass, copper or aluminum. Coated steel is typically used in applications such as automotive power steering lines, and aluminum is typically used in automotive air conditioning lines.

The main axis of the couplings described herein may be straight or curved, as desired to accommodate a curved main conduit. While the connection port 72, 172, 272, 372 is described as connecting to a second conduit, it may be capped, or remain unconnected until the aperture is formed in the main conduit.

While the invention has been described with respect to specific examples including preferred modes of carrying out the invention, those skilled in the art will appreciate that there are numerous variations and permutations of the above described systems and techniques that fall within the spirit and scope of the invention as set forth in the appended claims.

1. A fluid connector, comprising:
a hollow body defining a first opening, a second opening, a third opening and a main passageway interconnecting said first and second openings, wherein said third opening is in fluid communication with said main passageway, and wherein said main passageway selectively receives an integral conduit interposed therethrough.

2. The fluid connector of claim 1, further comprising a branch passageway connecting said third opening with said main passageway.

3. The fluid connector of claim 1, wherein said first and second openings are not in general axial alignment.

4. The fluid connector of claim 1, wherein said coupling can selectively form a seal with said tube between said first and second openings.

5. The fluid connector of claim 4, wherein said seal is disposed between at least a portion of said main passageway and an outer surface of the tube.

6. The fluid connector of claim 5, wherein said seal is an o-ring.

7. The fluid connector of claim 6, wherein there are a plurality of said seals, a first seal adjacent said first opening, and a second seal adjacent said second opening, said third opening positioned between said first and second seals.

8. The fluid connector of claim 7, further comprising at least two first seals and at least two second seals.

9. The fluid connector of claim 7, further comprising a piercing member for selectively piercing the integral conduit.

10. The fluid connector of claim 4, wherein said seal is formed during a crimping process.

11. The fluid connector of claim 1, wherein said hollow body is distorted to a pre-selected distorted shape, wherein said distorted shape limits relative axial movement between said connector and the integral conduit.

12. A coupling system for a plurality of fluid conduits, comprising:
a main conduit; and
a connector having a first end defining a first opening, a second end defining a second opening, and a main passageway extending therebetween, wherein said main conduit is interposed through said main passageway, and wherein a cross-section of said connector, taken normal to a main axis of said connector, defines a generally circular surface that extends around an outer surface of said main conduit.

13. The coupling system of claim 12, wherein said coupling defines a curved main axis.

14. The coupling system of claim 12, further comprising a seal between at least a portion of said main passageway and an outer surface of the main conduit.

15. The coupling system of claim 14, wherein said seal is an o-ring.

16. The coupling system of claim 14, wherein there are a plurality of said seals, a first seal adjacent said first opening, and a second seal adjacent said second opening, said third opening positioned between said first and second seals.

17. The coupling system of claim 12, further comprising a piercing member for selectively piercing the integral conduit.

18. The coupling system of claim 12, wherein at least a portion of said connector is distorted to a preselected distorted shape, wherein said distorted shape limits relative circumferential movement between said connector and the integral conduit.

19. A method of interconnecting a plurality of fluid conduits comprising the step of:
inserting a main conduit through a main passageway of a connector, wherein said main passageway is sealed around the circumference of at least a portion of said main conduit.

20. The method of claim 19, further comprising the step of securing said connector to said main conduit to restrict relative axial translation between said main conduit and said tube connector.

21. The method of claim 20, wherein the step of securing comprises crimping.

22. The method of claim 19, further comprising the step of connecting a branch conduit to a connecting port of said connector, wherein said branch conduit is selectively in fluid communication with said main conduit.

23. The method of claim 19 further comprising the step of forming an aperture in said main conduit.

24. The method of claim 23, further comprising the step of positioning said aperture within said main passageway.
